(19) United States
(12) Patent Application Publication
(10) Pub. No.: US 2010/0235515 A1
(43) Pub. Date: Sep. 16, 2010

(54) Method and apparatus for managing connection

(75) Inventors: Bong Ho Kim, San Jose, CA (US); Sang Heon Shin, Gyeonggi-do (KR); Ye Rang Hur, Los Gatos, CA (US)

Correspondence Address: BLANK ROME LLP, WATERGATE, 600 NEW HAMPSHIRE AVENUE, N.W., WASHINGTON, DC, 20037, US

(73) Assignee: POSCO ICT COMPANY LTD., Pohang-si (KR)

(21) Appl. No.: 12/659,190

(22) Filed: Feb. 26, 2010

Related U.S. Application Data
(60) Provisional application No. 61/160,417, filed on Mar. 16, 2009.

(30) Foreign Application Priority Data
Sep. 1, 2009 (KR) 10-2009-0081814

(51) Int. Cl. G06F 15/16

(52) U.S. Cl. 709/227

(57) ABSTRACT

A method and apparatus for managing connection is disclosed, which is capable of realizing an efficient management through a bi-directional connection, the method comprising pairing two uni-directional connections between a receiver and a transmitter, if Internet service to be provided requires bi-directional data delivery capability; and creating a second uni-directional connection by assigning the second uni-directional connection at the time of creating a first uni-directional connection for the Internet service, wherein the first uni-directional connection is opposite to the second uni-directional connection.

This application claims the benefit of the U.S. Provisional Application Ser. No. 61/160,417, filed on Mar. 16, 2009 and Korean Patent Application No. 10-2009-0081814, filed on Sep. 1, 2009, which are hereby incorporated by reference as if fully set forth herein.

### BACKGROUND OF THE INVENTION

1. Field of the Invention

The present invention relates to a wireless communication system, and more particularly, to a connection management in a wireless communication system.

2. Discussion of the Related Art

Most of Internet services require bi-directional data delivery capability over the network.

For example, VoIP consumes the same bandwidth on both downlink and uplink directions. Also, HTTP or FTP using TCP as a transport layer protocol requires a connection to deliver user/application data on one direction, and to deliver an acknowledgement message on the other direction, although the required bandwidth is heavily asymmetric on downlink and uplink directions.

In case of the recent IEEE 802.16e and wireless communication system, respective service flows or connections for data delivery are established and managed independently. In this respect, there are continuous researches and studies in efficient management of connection for data delivery.

### SUMMARY OF THE INVENTION

Accordingly, the present invention is directed to a method and apparatus for managing connection that substantially obviates one or more problems due to limitations and disadvantages of the related art.

An object of the present invention is to provide a method and apparatus for managing connection, which is capable of realizing an efficient management through a bi-directional connection.

Another object of the present invention is to provide a method and apparatus for managing connection, which is capable of reducing resource consumption.

Another object of the present invention is to provide a method and apparatus for managing connection, which is capable of reducing uplink delay or BWR message collision.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for managing connection comprising pairing two uni-directional connections between a receiver and a transmitter, if Internet service to be provided requires bi-directional data delivery capability; and creating a second uni-directional connection by assigning the second uni-directional connection at the time of creating a first uni-directional connection for the Internet service, wherein the first uni-directional connection is opposite to the second uni-directional connection. At this time, the Internet service is one of data packet services using at least VoIP, HTTP, or FTP.

The first uni-directional connection includes information about the second uni-directional connection, and the second uni-directional connection includes information about the first uni-directional connection. Also, the information about the first uni-directional connection corresponds to FID (Flow Identifier) of the first uni-directional connection, and the information about the second uni-directional connection corresponds to FID of the second uni-directional connection.

Also, different QoS parameters are assigned to each of the first and second uni-directional connections. Also, the first and second uni-directional connections are established by single management message exchange procedure.

In another aspect, there is provided a method for managing connection comprising establishing, changing, or releasing multiple connections using a single message transaction on a management connection between a base station and a mobile station, wherein the connection is established with a corresponding FID (Flow Identifier) assigned uniquely to each connection, and wherein the connection is established when an associated service flow mapped to each connection is generated, and the connection is released when the associated service flow mapped to each connection is removed.

At this time, the connection is a uni-directional transport connection. Also, the uni-directional transport connection is used to deliver user data between the base station and the mobile station.

At this time, the connection is pre-provisionally established for the corresponding mobile station during a network entry, or is dynamically created if required by the mobile station or base station.

The FID of the connection is maintained during handover.

In another aspect, there is provided an apparatus for managing connection comprising a means for establishing, changing, or releasing multiple connections using a single message transaction on a management connection between a base station and a mobile station; and a means for receiving and delivering the message, wherein the connection is established with a corresponding FID assigned uniquely to each connection, and wherein the connection is established when an associated service flow mapped to each connection is generated, and the connection is released when the associated service flow mapped to each connection is removed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a pairing of downlink and uplink connections according to one embodiment of the present invention;

FIG. 2 shows a related art connection setup procedure;

FIG. 3 shows a paired connection setup procedure according to the present invention; and

FIG. 4 shows a bandwidth allocation procedure on a paired connection according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Before describing the embodiment of the present invention, “connection” term to be used herein will be explained in brief.

The connection is to map a base station (hereinafter, referred to as “BS”) to MAC peers of one or more mobile stations (hereinafter, referred to as “MS”). When this mapping is applied between the BS and one MS, it is referred to as unicast connection. Meanwhile, when this mapping is applied between the BS and the plural MSs, it is referred to as a multicast or broadcast connection. The unicast connection is defined by 12 bit STID (Station Identifier) and 4 bit FID (Flow Identifier); and the multicast and broadcast connections are defined by reserved STID.

According to a purpose, the connection may be largely classified into a management connection and a transport connection. The management connection is used to deliver MAC management messages; and the transport connection is used to deliver user data. At this time, the user data includes upper layer signaling messages such as DHCP, and data plane signaling such as ARQ feedback. The MAC management messages cannot be delivered on the transport connection, and the user data cannot be delivered on the management connection.

Hereinafter, a method and apparatus for managing connection according to the present invention will be described with reference to the accompanying drawings.

In the method for managing connection according to one embodiment of the present invention, as shown in FIG. 1, if Internet service to be provided requires bi-directional data delivery capability, downlink and uplink connections are paired. As shown in FIG. 1, a bi-directional service flow can be established by pairing the downlink and uplink connections, that is, two uni-directional connections because each connection is mapped to a corresponding service flow.

Then, a counterpart connection is assigned at the time of creating the initial connection for the Internet service to be provided, to thereby establish paired uni-directional connections. In this case, each of the uni-directional connections should have information about the counterpart connection to be paired with. According to one embodiment of the present invention, the information about the counterpart connection may be FID to identify each connection, wherein each FID is assigned uniquely to each connection.

In the meantime, different QoS parameter sets may be assigned to each connection of the bi-directional service flow.

According to one embodiment of the present invention, the paired downlink and uplink connections can be established by one message exchange procedure which enables setup of the bi-direction service flow. In this case, a dynamic service addition message (hereinafter, referred to as “DSA message”) may be used for establishment of the paired downlink and uplink connections.

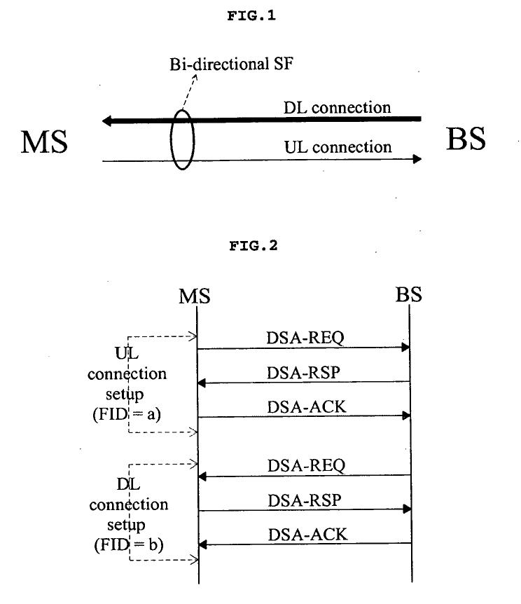

According as the paired downlink and uplink connections are established by only one message exchange procedure, it enables to reduce the connection establishment time on management of the bi-directional service flow. If the downlink and uplink connections are separately established on the downlink and uplink, as shown in FIG. 2, the DSA message exchange procedure should be performed independently for each of the connections, which would inevitably cause the increase of bandwidth usage.

Referring to FIG. 2, the related art method requires DSA-REQ message delivery, DSA-RSP message deliver, and DSA-ACK message delivery between the BS and the MS for the uplink connection setup with FID corresponding to ‘a’; and also requires DSA-REQ message delivery, DSA-RSP message deliver, and DSA-ACK message delivery between the BS and the MS for the downlink connection setup with FID corresponding to ‘b’.

However, in case of the present invention, the bi-direction service flow can be established by only one DSA message exchange procedure for the paired downlink and uplink connections.

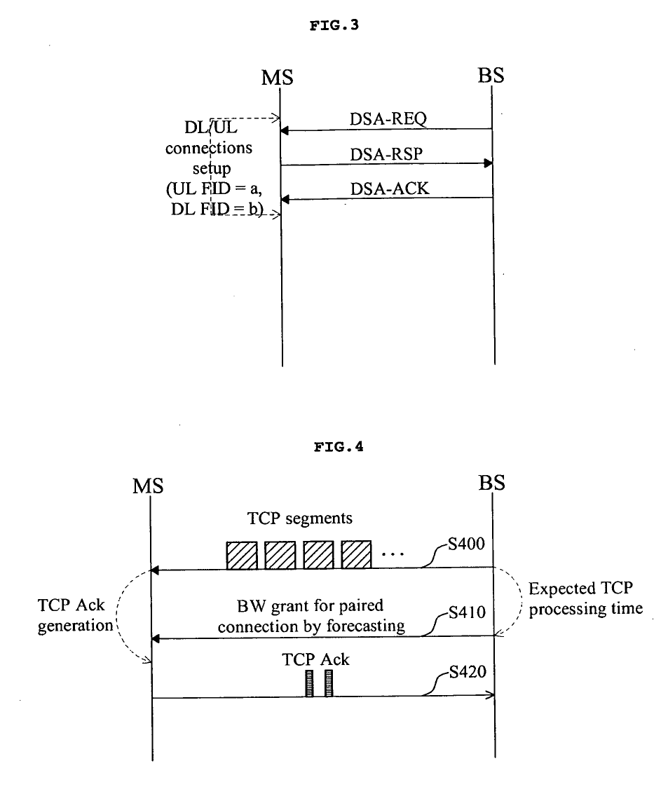

That is, as shown in FIG. 3, both the uplink connection setup with FID corresponding to ‘a’ and the downlink connection setup with FID corresponding to ‘b’ can be established by one DSA message exchange procedure (DSA-REQ message delivery, DSA-RSP message delivery, and DSA-ACK message delivery), to thereby reduce the overall service flow establishment time, and decrease the amount of the management traffic over the air.

Also, when the bi-direction service flow is established through the pairing of the downlink and uplink connections, it enables to eliminate the unnecessary service flow creation and deletion caused by the unavailability of the resource for the counterpart service flow which is required for a service. That is, if the counterpart service flow cannot be established, the initial service flow creation request may be rejected at the early stage.

This connection setup procedure can be performed by various types of transmitters and receivers, as well as the BS and the MS.

The aforementioned paired downlink and uplink connections according to the present invention can be used in various ways. In one embodiment of the present invention, the paired downlink and uplink connections may be used for an efficient bandwidth allocation.

In many cases, traffic on one direction is associated with the other direction. For example, in case of a TCP connection, a TCP acknowledgement message is generated on the opposite direction after a burst of TCP traffic.

Thus, It is predictable that the generation of uplink traffic before receiving a bandwidth request message (hereinafter, referred to as “BWR message”) by observing a downlink traffic pattern if the major traffic is on the downlink direction. It may be used to allocate uplink bandwidth preemptively to reduce BWR message collision or uplink delay.

This preemptive bandwidth allocation procedure will be explained in detail with reference to FIG. 4. FIG. 4 shows an example of preemptive bandwidth grant on the paired uplink connection for the TCP acknowledgement message delivery.

First, the user data is delivered over the TCP on the downlink direction in step 400. Then, the BS may be able to predict the generation of the acknowledgement messages for TCP segments after some processing time. Even though the BWR message from the MS is not received yet in the BS, the BS may send a bandwidth grant for the expected TCP acknowledgement message in step S420. Then, the BS receives the TCP acknowledgement message from the MS in step S420.

Through the aforementioned method, the TCP acknowledgement message can be delivered without collision or delay on the uplink direction.

The aforementioned method according to the embodiment of the present invention discloses that the paired downlink and uplink connections are established by single message transaction. In a modified embodiment of the present invention, MS and BS may establish/change/release multiple transport connections using a single message transaction on a management connection.

At this time, the transport connection corresponding to the uni-directional connection is established with the unique FID assigned by using the DSA procedure during the service flow establishment. Each transport connection is mapped to an active service flow so as to provide QoS of various levels required for the service flow. The transport connection is established when the associated active service flow is generated; and the transport connection is released when the associated active service flow is removed or non-active.

If once the transport connection is established, FID of the transport connection is not changed during handover.

In one embodiment of the present invention, QoS parameter sets of the management message for establishing the transport connection may include the associated FID which indicates that the connection is associated with another transport connection in the other direction.

In the aforementioned embodiment of the present invention, the transport connection may be pre-provisioned or dynamically created. Pre-provisioned connections are those established by system for MS during MS network entry. On the other hand, BS or MS can create new connections dynamically if required. The connection can be created, changed, or torn down on demand.

The aforementioned connection management method according to the embodiment of the present invention can be performed by a connection management apparatus. This connection management apparatus may be included in the BS or MS. The connection management apparatus may comprise a means for establishing connection, and a means for receiving and delivering message.

The means for establishing connection may establish, change, or release the multiple connections using a single message transaction on a management connection between the BS and the MS. In one embodiment of the present invention, the means for establishing connection pairs the first-directional connection with the second-directional connection in the multiple connections, wherein the first-directional connection is opposite to the second-directional connection; and establishes the second-directional connection by assigning the second-directional connection at the time of creating the first-directional connection.

At this time, the connection is used for the delivery of the user data between the BS and the MS, wherein the connection may be the uni-directional connection.

In one embodiment of the present invention, the message for establishing connection may be the DSA message; and the QoS parameter sets included in the message for establishing the first-directional connection may include the FID associated with the second-directional connection.

Then, the means for receiving and delivering message performs the message transaction for establishing the connection. At this time, the message for establishing connection may be the DSA message. Thus, the means for receiving and delivering message performs the DSA message transaction such as DSA-REQ message receiving and delivery, DSA-RSP message receiving and delivery, and DSA-ACK message receiving and delivery.

If the aforementioned connection management apparatus is included in the BS, the connection management apparatus may be used for the efficient bandwidth allocation. For this, the connection management apparatus may further a means for bandwidth grant, and a means for receiving and delivering data. At this time, the means for bandwidth grant predicts the generation of second data, wherein the second data corresponds to the acknowledgement message for first data delivered to the MS; and then previously grants the uplink bandwidth for delivery of the predicted second data to the MS. The means for receiving and delivering data delivers the first data to the MS on the downlink connection; and receives the second data from the MS on the uplink connection.

At this time, the second data may be the acknowledgement message for the first data.

The aforementioned connection management method according to the present invention can be embodied in type of program instruction which can be performed through the use of various computer means, and the embodied program instruction can be recorded in computer-readable recording media, for example, program instruction, data file, and data structure, solely or combiningly. The program instruction recorded in the record media may be especially designed for the present invention, or may be generally known to those skilled in the field of computer software.

According to the method and apparatus for managing connection of the present invention, the efficient management of the bi-directional connection can be realized by pairing the connections requiring the bi-directional data delivery capability.

Also, the downlink and uplink connections can be established by single message transaction, whereby it is possible to reduce the bandwidth consumed for establishing the connection.

Before receiving the BWR message, the generation of the uplink data can be predicted, and the uplink bandwidth can be preemptively allocated, to thereby reduce the uplink delay or BWR message collision.

Also, the connection is managed bi-directionally through the pairing of the downlink and uplink connections. Thus, if the service flow for any one of the connections cannot be established, the initial service flow creation request for the other connection can be rejected at the early stage, which enables to eliminate the unnecessary service flow creation and deletion.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for managing connection comprising:
pairing two uni-directional connections between a receiver and a transmitter, if Internet service to be provided requires bi-directional data delivery capability; and
creating a second uni-directional connection by assigning the second uni-directional connection at the time of creating a first uni-directional connection for the Internet service, wherein the first uni-directional connection is opposite to the second uni-directional connection.

2. The method according to claim 1, wherein the Internet service is one of data packet services using at least VoIP, HTTP, or FTP.

3. The method according to claim 1, wherein the first uni-directional connection includes information about the second uni-directional connection, and the second uni-directional connection includes information about the first uni-directional connection.

4. The method according to claim 3, wherein the information about the first uni-directional connection corresponds to FID (Flow Identifier) of the first uni-directional connection, and the information about the second uni-directional connection corresponds to FID of the second uni-directional connection.

5. The method according to claim 1, wherein different QoS parameters are assigned to each of the first and second uni-directional connections.

6. The method according to claim 1, wherein the first and second uni-directional connections are established by single management message exchange procedure.

7. A method for managing connection comprising establishing, changing, or releasing multiple connections using a single message transaction on a management connection between a base station and a mobile station,
wherein the connection is established with a corresponding FID (Flow Identifier) assigned uniquely to each connection, and
wherein the connection is established when an associated service flow mapped to each connection is generated, and the connection is released when the associated service flow mapped to each connection is removed.

8. The method according to claim 7, wherein the connection is a uni-directional transport connection.

9. The method according to claim 8, wherein the uni-directional transport connection is used to deliver user data between the base station and the mobile station.

10. The method according to claim 7, wherein the FID of the connection is maintained during handover.

11. The method according to claim 7, wherein the message is a DSA message.

12. The method according to claim 7, wherein the connection is pre-provisionally established for the corresponding mobile station during a network entry, or is dynamically created if required by the mobile station or base station.

13. The method according to claim 7, wherein QoS parameter sets included in the message for establishment of a first-directional connection include FID associated with a second-directional connection.

14. The method according to claim 7, wherein first data is firstly delivered on a first-directional connection; and second data is secondly received on a second-directional connection after predicting generation of the second data associated with the first data, and preemptively granting a bandwidth on the second-directional connection for delivery of the predicted second data.

15. An apparatus for managing connection comprising:
a means for establishing, changing, or releasing multiple connections using a single message transaction on a management connection between a base station and a mobile station; and
a means for receiving and delivering the message,
wherein the connection is established with a corresponding FID assigned uniquely to each connection, and
wherein the connection is established when an associated service flow mapped to each connection is generated, and the connection is released when the associated service flow mapped to each connection is removed.

16. The apparatus according to claim 15, wherein the connection is a uni-directional transport connection.

17. The apparatus according to claim 16, wherein the uni-directional transport connection is used to deliver user data between the base station and the mobile station.

18. The apparatus according to claim 15, wherein the means for establishing connection pairs a first-directional connection with a second-directional connection among the multiple connections, wherein the first-directional connection is opposite to the second-directional connection; and establishes the second-directional connection by assigning the second-directional connection at the time of creating the first-directional connection.

19. The apparatus according to claim 15, further comprising, if it is included in the base station,
a means for previously granting an uplink bandwidth for delivery of a second data to the mobile station by predicting generation of the second data, wherein the second data is an acknowledgement message for first data delivered to the mobile station; and
a means for delivering the first data to the mobile station on the downlink connection, and receiving the second data from the mobile station on the uplink connection.

20. The apparatus according to claim 15, wherein the message is a DSA message.

21. The apparatus according to claim 15, wherein QoS parameter sets included in the message for establishment of a first-directional connection include FID associated with a second-directional connection.
